(19) United States
(12) Patent Application Publication
(10) Pub. No.: US 2013/0067824 A1
(43) Pub. Date: Mar. 21, 2013

(54) ATTACHMENT OF THERMALLY STABLE POLYCRYSTALLINE TO A SUBSTRATE AND COMPACTS CONSTRUCTED

(71) Applicant: Varel International Ind., L.P., Carrollton, TX (US)

(72) Inventors: William W. King, Houston, TX (US); Federico Bellin, The Woodlands, TX (US)

(73) Assignee: Varel International Ind., L.P., Carrollton, TX (US)

(21) Appl. No.: 13/622,963

(22) Filed: Sep. 19, 2012

Related U.S. Application Data
(60) Provisional application No. 61/536,336, filed on Sep. 19, 2011.

(51) Int. Cl. B24D 18/00; B32B 37/06

(52) U.S. Cl. 51/297; 156/539

(57) ABSTRACT

A method and apparatus for fabricating a cutter. The method includes obtaining a compact including a cutting surface, a bonding interface, and a sidewall extending from the perimeter of the cutting surface to the perimeter of the bonding interface. The method includes obtaining a substrate including a bonding surface, a mounting surface, and a substrate sidewall extending from the perimeter of the bonding surface to the perimeter of the mounting surface. At least a portion of the bonding interface is positioned adjacent at least a portion of the bonding surface. At least one of the substrate and the compact is rotated to produce a rotational differential therebetween. The temperature is increased on at least the bonding surface to a first temperature. The compact is coupled to the substrate to form the cutter. The apparatus includes a first holder coupled to the compact and a second holder coupled to the substrate.

### CROSS-REFERENCE TO RELATED APPLICATIONS

This application claims priority under 35 U.S.C. §119 to U.S. Provisional Patent Application No. 61/536,336, titled “Attachment of Thermally Stable Polycrystalline to a Substrate and Compacts Constructed,” filed Sep. 19, 2011, the disclosure of which is incorporated by reference herein.

The present application is related to U.S. patent application Ser. No. 13/622,859, entitled “Thermal-Mechanical Wear testing for PDC Shear Cutters” and filed on Sep. 19, 2012, the disclosure of which is incorporated by reference herein.

### TECHNICAL FIELD

The present invention relates generally to cutters and methods of fabricating the cutters; and more particularly, to thermally stable polycrystalline (“TSP”) cutters and methods of coupling a thermally stable polycrystalline compact to a substrate to form the cutter.

### BACKGROUND

Polycrystalline diamond compacts (“PDC”) have been used in industrial applications, including rock drilling applications and metal machining applications. Such compacts have demonstrated advantages, such as better wear resistance and impact resistance, over some other types of cutting elements. Many different PDC grades have been developed trying to achieve at the same time the best wear abrasion and impact resistance. An un-backed PDC can be mechanically bonded to a tool (not shown), according to one example. Alternatively, the un-backed PDC can be bonded to a substrate material, which is described below in FIGS. 2 and 3, thereby forming a PDC substrate material, which is described below in FIGS. 2 and 3, thereby forming a PDC cutter, which is illustrated in FIG. 4. The PDC cutter is typically insertable within a downhole tool (not shown), such as a drill bit or a reamer.

FIG. 1A shows a cross-sectional view of a cutting table 100 in accordance with the prior art. FIG. 1B shows a schematic micro structural cross-sectional view of the cutting table 100 in accordance with the prior art. The cutting table 100 is formed from polycrystalline diamond (“PCD”), and is referred to as a PDC 100. Although the cutting table 100 is formed from PCD in the described exemplary embodiments, other types of cutting tables, including cubic boron nitride (“CBN”) compacts, are used in alternative exemplary embodiments. Referring to FIGS. 1A and 1B, the PDC 100 includes a cutting surface 112, a bonding interface 114, and a cutting table sidewall 116 extending from the perimeter of the cutting surface 112 to the perimeter of the bonding interface 114. According to certain exemplary embodiments, the cutting surface 112 is substantially planar; however, in other exemplary embodiments, the cutting surface 112 is non-planar. Similarly, in certain exemplary embodiments, the bonding interface 114 is substantially planar; however, in other exemplary embodiments, the bonding interface 114 is non-planar.

The PDC 100 can be formed by sintering individual diamond particles 150 together under the high pressure and high temperature (“HPHT”) conditions referred to as the “diamond stable region,” which is typically above forty kilobars and between 1,200 degrees Celsius and 2,000 degrees Celsius, in the presence of a catalyst/solvent 154 which promotes diamond-diamond bonding. Some examples of catalyst/solvent 154 typically used for sintering diamond compacts are cobalt, nickel, iron, and other Group VIII metals. PDCs 100 usually have a diamond content greater than seventy percent by volume, with about eighty percent to about ninety-five percent being typical. The diamond content can be greater or lesser than this range in other exemplary embodiments.

The PDC 100 includes diamond particles 150, one or more interstitial spaces 152 formed between the diamond particles 150, and cobalt 154 deposited within the interstitial spaces 152. During the sintering process, the interstitial spaces 152, or voids, are formed between the carbon-carbon bonds and are located between the diamond particles 150. The diffusion of cobalt 154 into the diamond powder results in cobalt 154 being deposited within these interstitial spaces 152 that are formed within the PDC 100 during the sintering process.

Once the PDC 100 is formed, the PDC 100 is known to wear quickly when the temperature reaches a critical temperature. This critical temperature is about 750 degrees Celsius and is reached when the PDC 100 is cutting rock formations or other hard materials. The high rate of wear is believed to be caused by the differences in the thermal expansion rate between the diamond particles 150 and the cobalt 154 and also by the chemical reaction, or graphitization, that occurs between cobalt 154 and the diamond particles 150. The coefficient of thermal expansion for the diamond particles 150 is about 1.0×10⁻⁶ millimeters⁻¹×Kelvin⁻¹ (“mm⁻¹K⁻¹”), while the coefficient of thermal expansion for the cobalt 154 is about 13.0×10⁻⁶ mm⁻¹ K⁻¹. Thus, the cobalt 154 expands much faster than the diamond particles 150 at temperatures above this critical temperature, thereby making the bonds between the diamond particles 150 unstable. The PDC 100 becomes thermally degraded at temperatures above about 750 degrees Celsius and its cutting efficiency deteriorates significantly.

Efforts have been made to slow the wear of the PDC 100 at these high temperatures. These efforts include performing an acid leaching process, or similar known process, on the PDC 100 which removes the cobalt 154 from the interstitial spaces 152, thereby forming a thermally stable polycrystalline (“TSP”) compact 200 as shown in FIG. 2. FIG. 2 illustrates a cross-sectional view of the TSP compact 200 once the catalyst 154 has been removed from the cutting table 100, or PDC, according to methods known in the prior art. Referring to FIGS. 1A-2, although the TSP compact 200 is formed when the cobalt 154 has been substantially removed from the entire PDC 100, the TSP compact 200 may still include some amounts of cobalt 154 therein, especially nearer a bonding interface 214. Typical leaching processes involve the presence of an acid solution (not shown) which reacts with the cobalt 154 that is deposited within the interstitial spaces 152 of the PDC 100. According to one example of a typical leaching process, the PDC 100 is placed in an acid solution and is at least partially or completely submerged therein. The acid solution reacts with the cobalt 154 along the outer surfaces of the PDC 100. The acid solution slowly moves inwardly within the interior of the PDC 100 and continues to react with the cobalt 154, thereby forming the TSP compact 200. Referring to FIG. 2, the TSP compact 200 is formed similarly to the PDC 100 and includes a cutting surface 212, the bonding interface 214, and a cutting table sidewall 216 extending from the perimeter of the cutting surface 212 to the perimeter of the bonding interface 214.

FIG. 3 shows a cross-sectional view of the substrate material 300 in accordance with the prior art. The substrate material 300 is formed from sintered metal-carbide 302, such as tungsten carbide. However, other metal-carbides, such as nickel-based carbides and molybdenum carbide, can be used to form the substrate material 300 without departing from the scope and spirit of the exemplary embodiments. The substrate material 300 includes a tungsten carbide powder and also a binder material 305, such as cobalt. Referring to FIG. 3, the substrate material 300 includes a bonding surface 312, a mounting surface 314, and a substrate sidewall 316 extending from the perimeter of the bonding surface 312 to the perimeter of the mounting surface 314. According to certain exemplary embodiments, the bonding surface 312 is substantially planar; however, in other exemplary embodiments, the bonding surface 312 is non-planar. In certain exemplary embodiments, the bonding surface 312 is complementary in shape to the bonding interface 214 (FIG. 2) of the TSP compact 200 (FIG. 2). Similarly, in certain exemplary embodiments, the mounting surface 314 is substantially planar; however, in other exemplary embodiments, the mounting surface 314 is non-planar. In some exemplary embodiments, the bonding surface 312 is rich in an alternative bonding material, such as silver or copper. The substrate material 300 may be formulated prior to pressing to be cobalt lean or cobalt free, and be silver or copper rich in this zone.

FIG. 4 shows a side view of a cutter 400 in accordance with the prior art. Referring to FIG. 4, the cutter 400 includes the TSP compact 200 coupled to the substrate material 300. Specifically, the bonding interface 214 is coupled to the bonding surface 312. Although the cutter 400 includes the TSP compact 200 bonded to the substrate material 300, there are challenges associated with this bonding.

Traditional brazing methods have been used to bond the TSP compact 200 to the substrate material 300. However, these traditional brazing methods have proved ineffective in achieving a high shear strength bond between the TSP compact 200 and the substrate material 300. These traditional brazing methods are described in U.S. Patent Application Publication Number 2006/0254830 issued to Radtke, which is incorporated by reference herein. These traditional brazing methods have not met with commercial success due to poor bonding of the TSP compact 200 to the substrate material 300.

Traditional HPHT methods also have been used to bond the TSP compact 200 to the substrate material 300. However, re-entry of the TSP compact 200 into an HPHT environment to press the TSP compact 200 to the substrate material 300 typically floods the TSP compact 200 with cobalt from the substrate material 300. This HPHT method renders the TSP compact 200 no longer thermally stable without the additional step of re-leaching at least the cutting surface 212 of the TSP compact 200. The traditional HPHT methods for reattaching the TSP compact 200 to the substrate material 300 is described in U.S. Pat. No. 5,127,923 issued to Bunting, which is incorporated by reference herein. These traditional HPHT methods have not met with commercial success due to high costs and additional post processing requirements to regain thermal stability.

### BRIEF DESCRIPTION OF THE DRAWINGS

The foregoing and other features and aspects of the invention are best understood with reference to the following description of certain exemplary embodiments, when read in conjunction with the accompanying drawings, wherein:

FIG. 1A shows a cross-sectional view of a cutting table in accordance with the prior art;

FIG. 1B shows a schematic microstructural cross-sectional view of the cutting table of FIG. 1A in accordance with the prior art;

FIG. 2 illustrates a cross-sectional view of the TSP compact once the catalyst has been removed from the cutting table of FIG. 1A in accordance with the prior art;

FIG. 3 shows a cross-sectional view of the substrate material in accordance with the prior art;

FIG. 4 shows a side view of a cutter in accordance with the prior art;

FIG. 5 shows a cross-sectional view of a TSP coupling device having the TSP compact of FIG. 2 coupled to a first holder and the substrate material of FIG. 3 coupled to a second holder in accordance with an exemplary embodiment of the present invention;

FIG. 6 shows a cross-sectional view of a cutter in accordance with an exemplary embodiment of the present invention;

FIG. 7 shows a side view of the TSP coupling device of FIG. 5 positioned within a control chamber in accordance with an exemplary embodiment of the present invention;

FIG. 8 shows an exploded cross-sectional view of a cutter in accordance with a second embodiment of the present invention;

FIG. 9 shows an exploded cross-sectional view of a cutter in accordance with a third embodiment of the present invention;

FIG. 10 shows an exploded cross-sectional view of a cutter in accordance with a fourth embodiment of the present invention;

FIG. 11 shows an exploded cross-sectional view of a cutter in accordance with a fifth embodiment of the present invention; and

FIG. 12 shows an exploded cross-sectional view of a cutter in accordance with a sixth embodiment of the present invention.

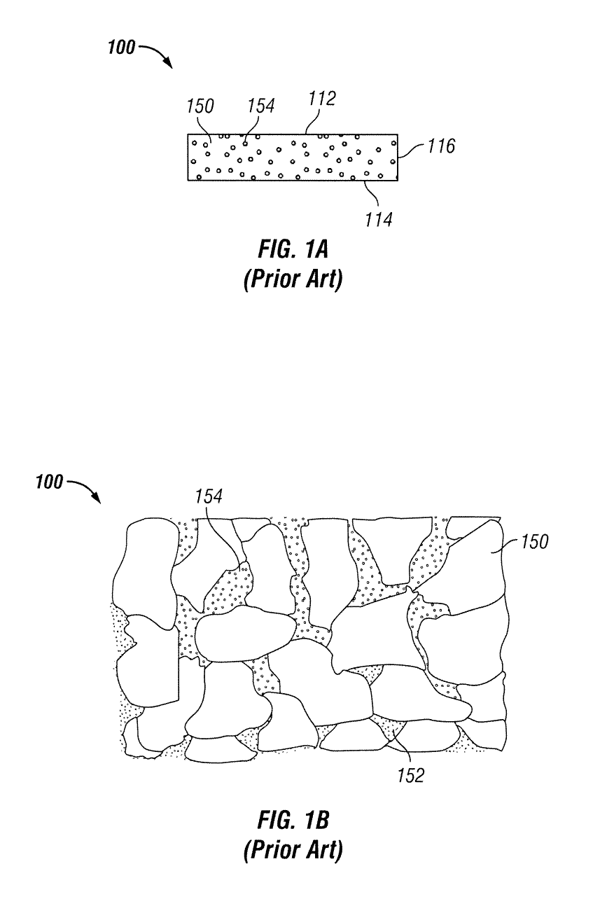

The drawings illustrate only exemplary embodiments of the invention and are therefore not to be considered limiting of its scope, as the invention may admit to other equally effective embodiments.

### BRIEF DESCRIPTION OF EXEMPLARY EMBODIMENTS

The present invention is directed generally to cutters and methods of fabricating the cutters; and more particularly, to thermally stable polycrystalline (“TSP”) cutters and methods of coupling a thermally stable polycrystalline compact to a substrate to form the TSP cutter. Although the description of exemplary embodiments is provided below in conjunction with a TSP cutter having a PCD compact, alternate embodiments of the invention may be applicable to other types of TSP cutters including, but not limited to, cutters having polycrystalline boron nitride (“PCBN”) compacts. As previously mentioned, the compact is mountable to a substrate to form a cutter or is mountable directly to a tool for performing cutting processes. The invention is better understood by reading the following description of non-limiting, exemplary embodiments with reference to the attached drawings, wherein like parts of each of the figures are identified by like reference characters, and which are briefly described as follows.

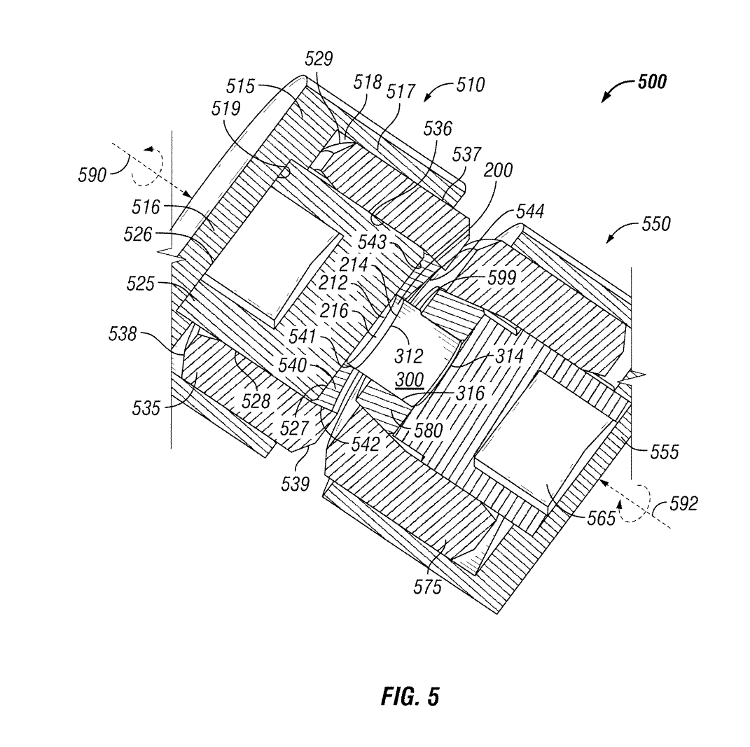

FIG. 5 shows a cross-sectional view of a TSP coupling device 500 having the TSP compact 200 coupled to a first holder 510 and the substrate material 300 coupled to a second holder 550 in accordance with an exemplary embodiment of the present invention. Referring to FIG. 5, the TSP coupling device 500 includes the first holder 510 and the second holder 550.

The first holder 510 includes a first holding tool 515, a first drive base 525, a first outer collet 535, and a first inner collet 540. However, in other exemplary embodiments, the first holder 510 includes fewer components, such as a first holding tool 515 and a first outer collet 535. The first holding tool 515 includes a base 516 and a sidewall 517 extending outwardly from the perimeter of the base 516 to form a cavity 518 therein. According to some exemplary embodiments, the base 516 is disk-shaped, but is shaped differently in other exemplary embodiments. The sidewall 517 extends outwardly from the base 516 in a substantially perpendicular manner according to certain exemplary embodiments. The portion of the base 516 facing the cavity 518 is non-planar in certain exemplary embodiments, and includes a recess 519 formed therein. The recess 519 is circularly-shaped, but is shaped differently in other exemplary embodiments. The recess 519 is centrally positioned within the base 516 according to some exemplary embodiments. This recess 519 is optional in certain exemplary embodiments. The first holding tool 515 is fabricated from steel; however, in other exemplary embodiments, the first holding tool 515 is fabricated from other known suitable materials, such as titanium and/or other metal alloys.

The first drive base 525 is cylindrically-shaped and includes a first end 526, a second end 527, and an outer wall 528 extending from the first end 526 to the second end 527. Alternatively, the first drive base 525 is shaped differently. In certain exemplary embodiments, the first end 526 is inserted within the recess 519. According to certain exemplary embodiments, the shape of the first end 526 corresponds to the shape of the recess 519 so that a portion of the first drive base 525 is insertable into the recess 519. Once the first drive base 525 is positioned within the cavity 518 and the first end 526 is positioned adjacent to the base 516, a gap 529 is formed between the outer wall 528 and the sidewall 517. The first drive base 525 is fabricated from steel. Alternatively, in other exemplary embodiments, the first drive base 525 is fabricated from other known suitable materials, such as titanium and/or other metal alloys.

The first outer collet 535 is annually shaped and includes a inner wall 536 and an outer wall 537 extending from a bottom end 538 to a top end 539. The first outer collet 535 is positioned within the gap 529, where the outer wall 537 of the first outer collet 535 is positioned adjacent to the inner portion of the first holding tool's sidewall 517 and the inner wall 536 of the first outer collet 535 is positioned adjacent to the outer portion of the first drive base's outer wall 528. The first outer collet 535 surrounds at least a portion of the first drive base 525. The first outer collet 535 is fitted securely within the gap 529 and ensures that the first drive base 525 is securely positioned within the first holding tool 515 and does not move freely within the first holding tool 515. Also, the top end 539 of the first outer collet 535 extends beyond the first drive base's second end 527 and is positioned further away from the base 516 than the first drive base's second end 527. Further, the top end 539 is tapered inwardly in certain exemplary embodiments. The first outer collet 535 is fabricated from steel. Alternatively, in other exemplary embodiments, the first outer collet 535 is fabricated from other known suitable materials, such as titanium and/or other metal alloys.

The first inner collet 540 also is annually shaped and includes a inner wall 541 and an outer wall 542 extending from a bottom end 543 to a top end 544. The first inner collet 540 is positioned within an area bounded by the first outer collet's inner wall 536. Also, the fist inner collet's bottom end 543 is positioned adjacent the first drive base's second end 527 and the first inner collet's outer wall 542 is positioned adjacent the first outer collet's inner wall 536. The first inner collet 540 is fitted securely within the first outer collet 535, such that the first inner collet 540 does not move freely within the first outer collet 535. The top end 539 of the first outer collet 535 is tapered inwardly and provides the compressive force to keep the first inner collet 540 secured therein. In certain exemplary embodiments, the inner wall 541 is shorter than the outer wall 542; however, in other exemplary embodiments, the length of the inner wall 541 is greater than or about equal to the length of the outer wall 542. The first inner collet 540 is fabricated from steel. Alternatively, in other exemplary embodiments, the first inner collet 540 is fabricated from other known suitable materials, such as titanium and/or other metal alloys.

The second holder 550 is formed similarly to the first holder 510 and includes a second holding tool 555, a second drive base 565, a second outer collet 575, and a second inner collet 580. However, in other exemplary embodiments, the second holder 550 includes fewer components, such as a second holding tool 555 and a second outer collet 575. The second holding tool 555 is formed similarly to the first holding tool 515 and is not repeated again herein for the sake of brevity. Similarly, the second drive base 565 is formed and is positioned similarly as the first drive base 525 and is not repeated again herein for the sake of brevity. Also, the second outer collet 575 is formed and is positioned similarly as the first outer collet 535 and is not repeated again herein for the sake of brevity. Moreover, the second inner collet 580 is formed and is positioned similarly as the first inner collet 540 and is not repeated again herein for the sake of brevity.

Once the first holder 510 is assembled, the TSP compact 200 is coupled, or mounted, to the first holder 510. The cutting surface 212 is positioned adjacent to and in contact with the first drive base's second end 527 and at least a portion of the cutting table sidewall 216 is surrounded by and in contact with the first inner collet's inner wall 541. Thus, the bonding interface 214 is facing a direction away from the first drive base 525. The first inner collet's inner wall 541 facilitates maintaining the position of the TSP compact 200 securely to the first holder 510. In certain exemplary embodiments, the first inner collet 540 provides a compressive force onto the TSP compact 200.

Once the second holder 550 is assembled, the substrate material 300 is coupled, or mounted, to the second holder 550. The mounting surface 314 is positioned adjacent to and in contact with the second drive base 565 and at least a portion of the substrate sidewall 316 is surrounded by and in contact with the second inner collet 580. Thus, the bonding surface 312 is facing a direction away from the second drive base 565. The second inner collet 580 facilitates maintaining the position of the substrate material 300 securely to the second holder 550. In certain exemplary embodiments, the second inner collet 580 provides a compressive force onto the substrate material 300.

According to one exemplary embodiment for bonding the TSP compact 200 to the substrate material 300, the first holder 510 having the TSP compact 200 is brought into contact with the second holder 550 having the substrate material 300. Specifically, the TSP compact's bonding interface 214 is brought into contact with the substrate material's bonding surface 312. At least one of the first holder 510 and the second holder 550 is rotated to create a rapid frictional heating at the interface of where the TSP compact's bonding interface 214 is in contact with the substrate material's bonding surface 312. Although heating of the interface is performed by rotating at least one of the TSP compact 200 and the substrate material 300, the interface heating is performed using other known apparatuses and methods that are known to persons having ordinary skill in the art and having the benefit of the present disclosure. Also, at least during the rotation of at least one of the first holder 510 and the second holder 550, a load 590, 592 is applied, either directly or indirectly, to at least one of the TSP compact 200 and the substrate material 300 to at least ensure that the TSP compact 200 remains in contact with the substrate material 300 and that the TSP compact 200 and the substrate material 300 are being forced into one another to facilitate the bonding between the TSP compact 200 and the substrate material 300. The loads 590, 592 range from about five Newtons to about 2,500 Newtons. According to some exemplary embodiments, the loads 590, 592 range from about 500 Newtons to about 1,500 Newtons.

During this portion of the bonding process, the temperature of the TSP compact's bonding interface 214 and the substrate material's bonding surface 312 is increased to a first temperature. This first temperature is equal to or greater than the melting temperature of the binder material 305 (FIG. 3). Thus, a portion of the binder material 305 (FIG. 3), located within the substrate material 300 near the substrate material's bonding surface 312, melts and infiltrates into the TSP compact 200. The average temperature of the TSP compact 200 is a second temperature, which is different than the first temperature. The average temperature of the substrate material 300 is a third temperature, which is different than the first temperature and the second temperature. In certain exemplary embodiments, the second temperature is lower than or equal to the third temperature. Once infiltration of the binder material 305 (FIG. 3) occurs into the TSP compact 200, the substrate material 300 is pushed into the TSP compact 200 and thus at least one of the substrate material 300 and/or the TSP compact 200 is displaced a lateral distance. When the lateral displacement occurs, the rotation of both TSP compact 200 and the substrate material 300 is ceased, either manually upon observance of the lateral displacement or automatically via a sensor detector (not shown) that detects the lateral displacement. The loads 590, 592 are maintained for at least two seconds after rotation of both the TSP compact 200 and the substrate material 300 has ceased in certain exemplary embodiments. This ensures that the infiltrated binder material 305 (FIG. 3), or cobalt, re-solidifies within the TSP compact 200. In other exemplary embodiments, the loads 590, 592 are maintained for a time period ranging from two seconds to two days. Using this frictional heating process to bond the TSP compact 200 to the substrate material 300, a high shear strength bond is formed between the TSP compact 200 and the substrate material 300, thereby forming the cutter 599. The cutter 599 is then removed from the holders 510, 550 and the respective inner collets 540, 580. Once the second inner collet 580 is removed from the substrate 300, the substrate 300 expands since the force that the second inner collet 580 applied onto the substrate 300 is removed. The expansion of the substrate 300 causes the TSP compact 200 to be in compression. Therefore, the TSP compact 200 is in a state of residual stress, which increases its strength.

In certain exemplary embodiments of the bonding process described above, only the first holder 510 rotates, while the second holder 550 is substantially static. In another exemplary embodiment, only the second holder 550 rotates, while the first holder 510 is substantially static. In yet another exemplary embodiment, the first holder 510 and the second holder 550 both rotate, but the first holder 510 rotates in an opposite direction than the direction in which the second holder 550 rotates. In a further exemplary embodiment, the first holder 510 and the second holder 550 both rotate in the same direction, but one of the first holder 510 or the second holder 550 rotates faster than the other holder 510, 550. Although it is mentioned that at least one of the holders 510, 550 is rotated, it can be that at least one of the TSP compact 200 and the substrate material 300 is rotated in lieu of the respective holder 510, 550.

The rotational differential between the TSP compact 200 and the substrate material 300, or between the first holder 510 and the second holder 550, for at least a portion of the bonding process ranges from about 1,000 revolutions per minute (“RPM”) to about 7,000 RPM. In certain other exemplary embodiments, the rotational differential ranges between about 2,500 RPM to about 5,500 RPM. According to certain exemplary embodiments, the rotation of at least one of the TSP compact 200 and the substrate material 300 is performed increasingly in a step-up process. According to certain other exemplary embodiments, the rotation of at least one of the TSP compact 200 and the substrate material 300 is performed increasingly in a continuous manner. According to yet other exemplary embodiments, the rotation of at least one of the TSP compact 200 and the substrate material 300 is performed increasingly in a combination of manners, for example, a step-up process and a continuous manner. Similarly, the rotation of at least one of the TSP compact 200 and the substrate material 300 is performed decreasingly in any one of a step-down process, a continuous manner, or a combination of a step-down process and a continuous manner.

In some exemplary embodiments, one or more of the first holder 510 and the second holder 550 are in rotation prior to the TSP compact 200 being brought into contact with the substrate material 300. In other exemplary embodiments, the TSP compact 200 is brought into contact with the substrate material 300 prior to any of the holders 510, 550, or components 200, 300, being put into rotation.

In certain exemplary embodiments of the bonding process described above, the first load 590 is applied to the first holder's base 516. In another exemplary embodiment, the second load 592 is applied onto the second holder 555. In yet another exemplary embodiment, the first load 590 is applied onto the first holder's base 516 and the second load 592 is applied onto the second holder 555. In certain exemplary embodiments, one or more of the loads 590, 592 are maintained on the respective holder 510, 550 after the rotation of both of the holders 510, 550 has ceased. The apparatus and methods for providing the loads 590, 592 and the rotations of the TSP compact 200 and/or the substrate material 300 are known to people having ordinary skill in the art having the benefit of the present disclosure and will not be discussed in detail herein for the sake of brevity. In certain exemplary embodiments, one or more steps in the bonding process, such as the rotation of the substrate material 300 and/or the TSP compact 200 or the applied loads 590, 592, are controlled and operated by a computer (not shown).

Although not illustrated, in certain exemplary embodiments, one or more fins (not shown) are coupled to, or mounted to, the cutting surface 212. These fins provide cooling of the TSP compact 200 during the bonding process. Thus, the infiltration of the cobalt into the TSP compact 200 is limited to a lesser distance because of the enhanced cooling that occurs due to the fins. Also although not illustrated, in certain exemplary embodiments, a heater (not shown) is coupled to, or mounted to, the substrate material 300. This heater provides heat to the substrate material 300 during the bonding process. Thus, the cobalt within the substrate material 300 melts more quickly than is the heater was not present. This additional heat provided by the heater reduces the frictional heat required to melt the cobalt, and thus the RPMs also are reduced.

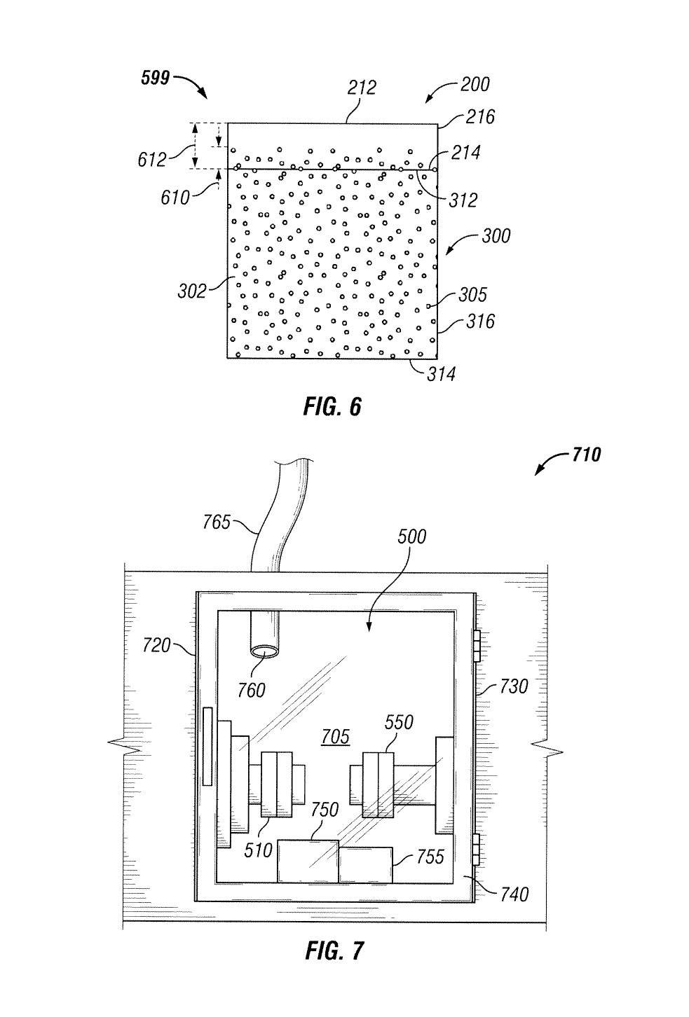

FIG. 6 shows a cross-sectional view of the cutter 599 in accordance with an exemplary embodiment of the present invention. The cutter 599 includes the TSP compact 200 coupled to the substrate material 300 using the TSP coupling device 500 (FIG. 5) described above. Referring to FIG. 6, the TSP compact 200 includes the cutting surface 212, the bonding interface 214, and the cutting table sidewall 216 extending from the perimeter of the cutting surface 212 to the perimeter of the bonding interface 214. The substrate material 300 includes the tungsten carbide powder 302 and also the binder material 305, such as cobalt. The substrate material 300 also includes the bonding surface 312, the mounting surface 314, and the substrate sidewall 316 extending from the perimeter of the bonding surface 312 to the perimeter of the mounting surface 314.

Upon performing the bonding process described above, the binder material 305 infiltrates into the TSP compact 200 from the substrate material 300. The infiltration of the binder material 305 proceeds from the bonding interface 214 towards the cutting surface 212. In certain exemplary embodiments, the binder material 305 infiltrates into the TSP compact 200 an infiltration distance 610 that ranges from about two percent to about eighty percent of the height 612 of the TSP compact 200, which extends from the bonding interface 214 to the cutting surface 212. In other exemplary embodiments, the infiltration distance 610 ranges from about two percent to about sixty-seven percent of the height 612. In yet other exemplary embodiments, the infiltration distance 610 ranges from about two percent to about forty percent of the height 612. The resulting cutter 599 exhibits the shear strength of a traditional PDC cutter and the high thermal resistant properties of a TSP cutter.

FIG. 7 shows a side view of the TSP coupling device 500 positioned at within a control chamber 710 in accordance with an exemplary embodiment of the present invention. The control chamber 710 includes a first wall 720, a second wall 730 positioned opposite the first wall 720, and a door 740 extending from an edge of the first wall 720 to an edge of the second wall 730. The door 740 opens and closes, either by pivoting about the edge of one of the walls 720, 730, or sliding horizontally, to provide access to the TSP coupling device 500. The control chamber 710 is substantially cube-shaped and defines a cavity 705 formed therein. The control chamber 710 is air-tight when the door 740 is closed according to some exemplary embodiments. However, in other exemplary embodiments, the control chamber 710 is not air-tight when the door 740 is closed.

The environment within the cavity 705 is controllable in certain exemplary embodiments. For example, a heater 750 is optionally positioned within the cavity 705 to allow the bonding process to occur at an elevated temperature when compared to ambient temperature. The heater 750 preheats the TSP compact 200 and the substrate material 300 prior to their bonding via spin, or rotation, thereby reducing the potential for thermal shock. Alternatively, a cooler 755 is optionally positioned within the cavity 705 to allow the bonding process to occur at a lower temperature when compared to ambient temperature. In another example, the control chamber 710 includes an air opening 760 which is coupled to an air hose 765 for controlling the pressure within the control chamber 710. Air, or some other gas, such as an inert gas, enters into the cavity 705 to increase the pressure therein. A compressor (not shown) is coupled to one end of the air hose 765 and used to push the air, or gas, into the cavity 705 according to some exemplary embodiments. Alternatively, the pressure within the cavity 705 is in a vacuum state or less than atmospheric pressure, in which the air, or gas, is withdrawn from within the cavity 705 through the air opening 760 and the air hose 765. The inert atmosphere or the vacuum atmosphere reduces the potential for graphitization of the diamond at the interface of the substrate material 300 and the TSP compact 200. Thus, the temperature and pressure is controllable within the control chamber 710 and therefore the bonding process is performable within any combination of desired temperature and desired pressure.

As previously mentioned, the TSP coupling device 500 includes the first holder 510 and the second holder 550. The first holder 510 is rotatably coupled to the first wall 720, while the second holder 550 is rotatably coupled to the second wall 730. However, in other exemplary embodiments, one or more of the first holder 510 and the second holder 550 are entirely positioned within the cavity 705 and are not coupled to either of the first wall 720 or the second wall 730. The rotation and/or the load applied to any one of the first holder 510 and/or the second holder 550, which is positioned at least partially within the control chamber 710 is known to persons having ordinary skill in the art having the benefit of the present disclosure. For example, one or more seals (not shown) can be used where the holders 510, 550 are in contact with the control chamber 710 to maintain an air-tight control chamber 710. In certain exemplary embodiments, one or more steps in the bonding process, such as pressure control and/or temperature control, are controlled and operated by a computer (not shown).

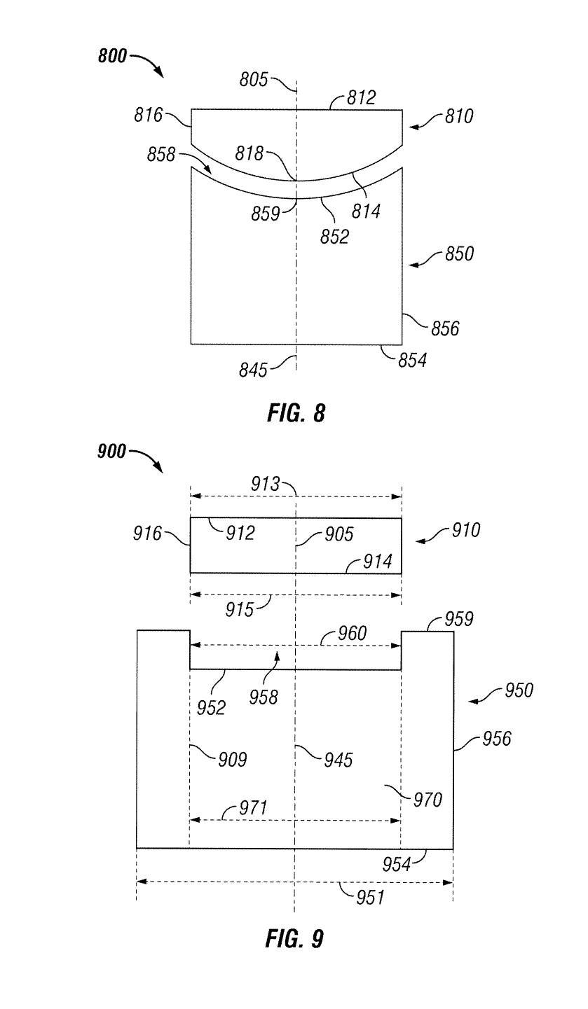

FIG. 8 shows an exploded cross-sectional view of a cutter 800 in accordance with a second embodiment of the present invention. The cutter 800 includes a TSP compact 810 coupled, or bonded, to a substrate material 850. According to certain exemplary embodiments, the TSP compact 810 is coupled, or bonded, to the substrate material 810 using the TSP coupling device 500 (FIG. 5) described above, or some other device capable of producing frictional heat along the interface between the TSP compact 810 and the substrate material 850. For the sake of clarity, the presence of binder material within the substrate material 850, which is similar to the binder material 305 (FIG. 3), is not illustrated in FIG. 8.

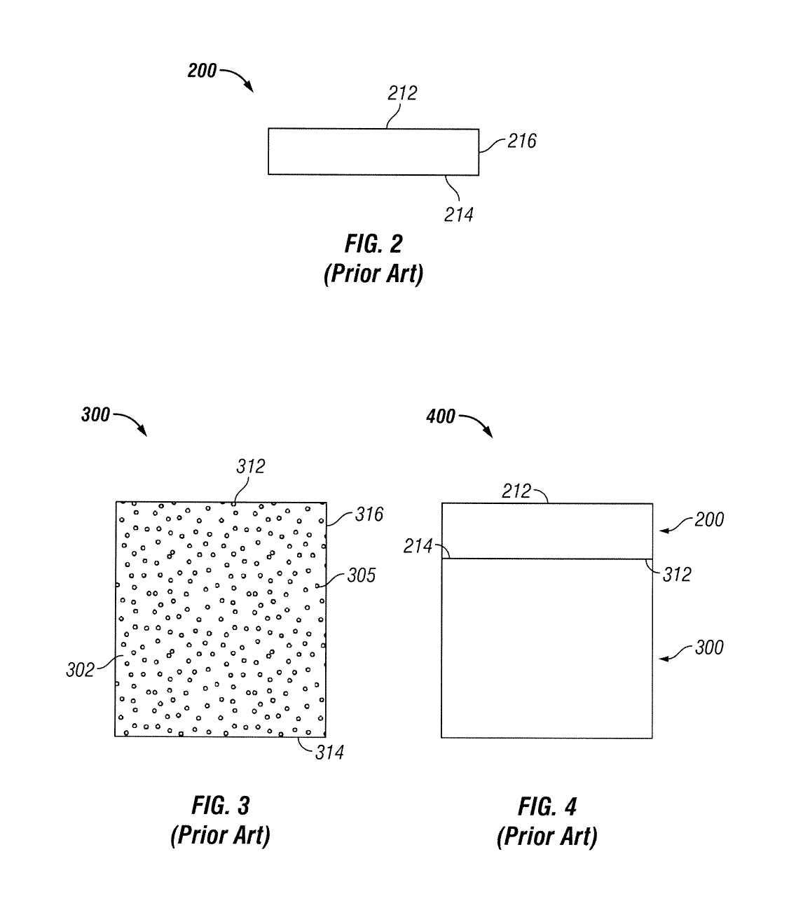

The TSP compact 810 is formed and fabricated similarly to the TSP compact 200 (FIG. 2), except for its shape. The TSP compact 810 includes a cutting surface 812, a bonding interface 814, and a cutting table sidewall 816 extending from the perimeter of the cutting surface 812 to the perimeter of the bonding interface 814. According to certain exemplary embodiments, the cutting surface 812 is substantially planar; however, in other exemplary embodiments, the cutting surface 812 is non-planar. The bonding interface 814 is substantially non-planar. In certain exemplary embodiments, the bonding interface 814 is convex-shaped, or dome-shaped, and includes an apex 818 positioned substantially on a compact central axis 805 that extends centrally through the TSP compact 810. The surface of the bonding interface 814 is substantially smooth; however, the surface is not smooth in other exemplary embodiments.

The substrate material 850 is formed and fabricated similarly to the substrate material 300 (FIG. 3), except for its shape. The substrate material 850 includes a bonding surface 852, a mounting surface 854, and a substrate sidewall 856 extending from the perimeter of the bonding surface 852 to the perimeter of the mounting surface 854. In certain exemplary embodiments, the mounting surface 854 is substantially planar; however, in other exemplary embodiments, the mounting surface 854 is non-planar. According to certain exemplary embodiments, the bonding surface 852 is substantially non-planar. In certain exemplary embodiments, the bonding surface 852 is concave-shaped and includes a recess 858 formed therein. The recess 858 includes a low point 859 positioned substantially on a substrate central axis 845 that extends centrally through the substrate material 850. The surface of the bonding surface 852 is substantially smooth; however, the surface is not smooth in other exemplary embodiments. In certain exemplary embodiments, the bonding surface 852 is complementary in shape to the bonding interface 814 of the TSP compact 810. Thus, the bonding interface 814 of the TSP compact 810 is positioned securely within the recess 858 of the substrate material 850 during the process of coupling the TSP compact 810 to the substrate material 850. This shape of the TSP compact 810 and the substrate material 850 is one example that reduces any misalignment of the TSP compact 810 with the substrate material 850 and maintains the positioning of the TSP compact 810 with respect to the substrate material 850 during the coupling process. Once the TSP compact 810 is coupled, or bonded, to the substrate material 850 pursuant to the description provided above, the compact central axis 805 is aligned with the substrate central axis 845 and the bonding interface 814 is coupled adjacent to the bonding surface 854. Also, the apex 818 is positioned adjacent to the low point 859. The bonding process is performed substantially similar to that previously described.

FIG. 9 shows an exploded cross-sectional view of a cutter 900 in accordance with a third embodiment of the present invention. The cutter 900 includes a TSP compact 910 coupled to a substrate material 950. According to certain exemplary embodiments, the TSP compact 910 is coupled, or bonded, to the substrate material 910 using the TSP coupling device 500 (FIG. 5) described above, or some other device capable of producing frictional heat along the interface between the TSP compact 910 and the substrate material 950. For the sake of clarity, the presence of binder material within the substrate material 950, which is similar to the binder material 305 (FIG. 3), is not illustrated in FIG. 9.

The TSP compact 910 is formed and fabricated similarly to the TSP compact 200 (FIG. 2). The TSP compact 910 includes a cutting surface 912, a bonding interface 914, and a cutting table sidewall 916 extending from the perimeter of the cutting surface 912 to the perimeter of the bonding interface 914. According to certain exemplary embodiments, the cutting surface 912 is substantially planar; however, in other exemplary embodiments, the cutting surface 912 is non-planar. Similarly, in certain exemplary embodiments, the bonding interface 914 is substantially planar; however, in other exemplary embodiments, the bonding interface 914 is non-planar. The surface of the bonding interface 914 is substantially smooth; however, the surface is not smooth in other exemplary embodiments. Also, the bonding interface 914 includes a compact central axis 905 that extends centrally through the TSP compact 910. Further, the bonding interface 914 is formed having a bonding interface diameter 915. In certain exemplary embodiments, the cutting surface 912 is formed having a cutting surface diameter 913 that is either equal to, greater than, or less than the bonding interface diameter 915.

The substrate material 950 is formed and fabricated similarly to the substrate material 300 (FIG. 3), except for its shape. The substrate material 950 includes a bonding surface 952, a mounting surface 954, and a substrate sidewall 956 extending from the perimeter of the bonding surface 952 to the perimeter of the mounting surface 954. The substrate material 950 is formed having a substrate diameter 951 greater than bonding interface diameter 915. In certain exemplary embodiments, the mounting surface 954 is substantially planar; however, in other exemplary embodiments, the mounting surface 954 is non-planar. According to certain exemplary embodiments, the bonding surface 952 is substantially non-planar. In certain exemplary embodiments, the bonding surface 952 includes a recess 958 formed therein, thereby also forming a protrusion area 959 extending circumferentially around the recess 958. The recess 958 is circularly shaped and includes a recess diameter 960 that is substantially equal to the bonding interface diameter 915. Alternatively, the recess 958 and the bonding interface 914 are shaped differently in other exemplary embodiments. A portion of the TSP compact 910, which includes the bonding interface 914 is inserted into the recess 958 and coupled to a portion of the bonding surface 952. The substrate material 950 includes a substrate central axis 945 that extends centrally through the substrate material 950. The surface of the bonding surface 952 is substantially smooth; however, the surface is not smooth in other exemplary embodiments. The bonding surface 952 is complementary in shape to the bonding interface 914 of the TSP compact 910. Thus, the bonding interface 914 of the TSP compact 910 is positioned securely within the recess 958 of the substrate material 950 during the process of coupling the TSP compact 910 to the substrate material 950. This shape of the TSP compact 910 and the substrate material 950 is one example that reduces any misalignment of the TSP compact 910 with the substrate material 950 and maintains the positioning of the TSP compact 910 with respect to the substrate material 950 during the coupling process. Once the TSP compact 910 is coupled, or bonded, to the substrate material 950 pursuant to the description provided above, the compact central axis 905 is aligned with the substrate central axis 945 and the bonding interface 914 is coupled adjacent to the bonding surface 952. The bonding process is performed substantially similar to that previously described.

In exemplary embodiments where the substrate material 950 has a substrate diameter 951 that is greater than the cutting surface diameter 913, once the TSP compact 910 is coupled to the substrate material 950, a portion of the substrate material 950 that extends beyond the profile of the TSP compact 910, when viewed from above, is removed along a compact profile line 909 pursuant to methods known to persons having ordinary skill in the art, for example, laser trimming. Hence, a resulting substrate material 970 has a resulting diameter 971 that is substantially equal to the cutting surface diameter 913 and/or the bonding interface diameter 915.

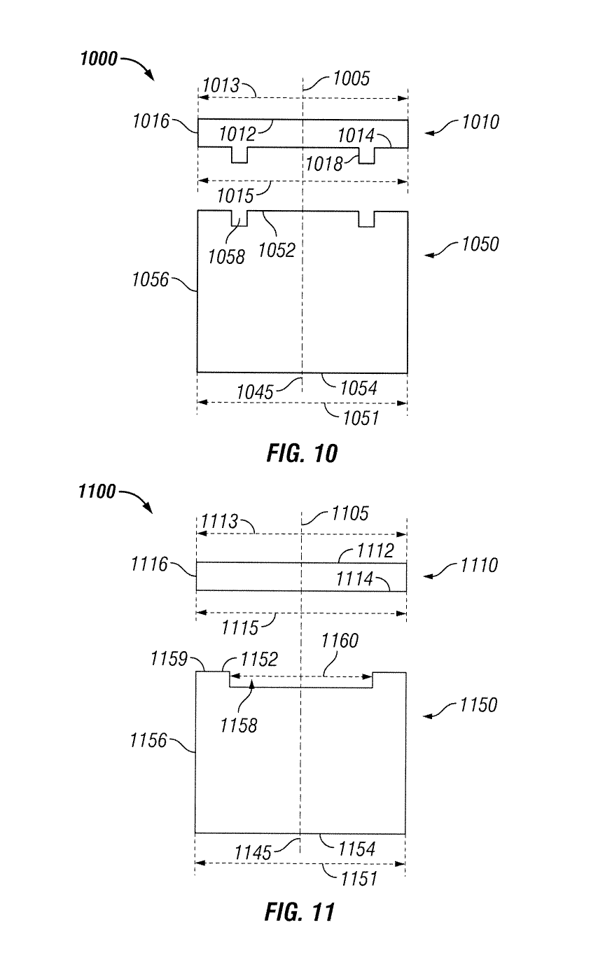

FIG. 10 shows an exploded cross-sectional view of a cutter 1000 in accordance with a fourth embodiment of the present invention. The cutter 1000 includes a TSP compact 1010 coupled to a substrate material 1050. According to certain exemplary embodiments, the TSP compact 1010 is coupled, or bonded, to the substrate material 1010 using the TSP coupling device 500 (FIG. 5) described above, or some other device capable of producing frictional heat along the interface between the TSP compact 1010 and the substrate material 1050. For the sake of clarity, the presence of binder material within the substrate material 1050, which is similar to the binder material 305 (FIG. 3), is not illustrated in FIG. 10.

The TSP compact 1010 is formed and fabricated similarly to the TSP compact 200 (FIG. 2). The TSP compact 1010 includes a cutting surface 1012, a bonding interface 1014, and a cutting table sidewall 1016 extending from the perimeter of the cutting surface 1012 to the perimeter of the bonding interface 1014. According to certain exemplary embodiments, the cutting surface 1012 is substantially planar; however, in other exemplary embodiments, the cutting surface 1012 is non-planar. In certain exemplary embodiments, the bonding interface 1014 is substantially non-planar; however, in other exemplary embodiments, the bonding interface 1014 is planar. The bonding interface 1014 includes a compact central axis 1005 that extends centrally through the TSP compact 1010. The bonding interface 1014 also includes one or more protrusions 1018 extending outwardly from the surface of the remaining portion of the bonding interface 1014. In some exemplary embodiments, the protrusion 1018 extends circumferentially around the compact central axis 1005 and is circular in shape. Alternatively, the protrusion 1018 is shaped into a segment of a circle. Further, the bonding interface 1014 is formed having a bonding interface diameter 1015. In certain exemplary embodiments, the cutting surface 1012 is formed having a cutting surface diameter 1013 that is either equal to, greater than, or less than the bonding interface diameter 1015.

The substrate material 1050 is formed and fabricated similarly to the substrate material 300 (FIG. 3), except for its shape. The substrate material 1050 includes a bonding surface 1052, a mounting surface 1054, and a substrate sidewall 1056 extending from the perimeter of the bonding surface 1052 to the perimeter of the mounting surface 1054. The substrate material 1050 is formed having a substrate diameter 1051 that is similar in size to the bonding interface diameter 1015. In certain exemplary embodiments, the mounting surface 1054 is substantially planar; however, in other exemplary embodiments, the mounting surface 1054 is non-planar. According to certain exemplary embodiments, the bonding surface 1052 is substantially non-planar. The substrate material 1050 includes a substrate central axis 1045 that extends centrally through the substrate material 1050. In certain exemplary embodiments, the bonding surface 1052 also includes a groove 1058 formed therein and extending into the substrate material 1050 towards the mounting surface 1054. The groove 1058 extends circumferentially around the substrate central axis 1058 and is dimensioned to receive the one or more protrusions 1018 therein. Once the protrusions 1018 are inserted into the groove 1058, the bonding interface 1014 is in contact with the bonding surface 1052 and the TSP compact 1010 is coupled, or bonded, to the substrate material 1050 pursuant to the methods described above. The bonding surface 1052 is complementary in shape to the bonding interface 1014 of the TSP compact 1010 according to certain exemplary embodiments. The protrusions 1018 of the TSP compact 1010 is positioned securely within the groove 1058 of the substrate material 1050 during the process of coupling the TSP compact 1010 to the substrate material 1050. This shape of the TSP compact 1010 and the substrate material 1050 is one example that reduces any misalignment of the TSP compact 1010 with the substrate material 1050 and maintains the positioning of the TSP compact 1010 with respect to the substrate material 1050 during the coupling process. Once the TSP compact 1010 is coupled, or bonded, to the substrate material 1050 pursuant to the description provided above, the compact central axis 1005 is aligned with the substrate central axis 1045 and the bonding interface 1014 is coupled adjacent to the bonding surface 1052. The bonding process is performed substantially similar to that previously described.

FIG. 11 shows an exploded cross-sectional view of a cutter 1100 in accordance with a fifth embodiment of the present invention. The cutter 1100 includes a TSP compact 1110 coupled to a substrate material 1150. According to certain exemplary embodiments, the TSP compact 1110 is coupled, or bonded, to the substrate material 1110 using the TSP coupling device 500 (FIG. 5) described above, or some other device capable of producing frictional heat along the interface between the TSP compact 1110 and the substrate material 1150. For the sake of clarity, the presence of binder material within the substrate material 1150, which is similar to the binder material 305 (FIG. 3), is not illustrated in FIG. 11.

The TSP compact 1110 is formed and fabricated similarly to the TSP compact 200 (FIG. 2). The TSP compact 1110 includes a cutting surface 1112, a bonding interface 1114, and a cutting table sidewall 1116 extending from the perimeter of the cutting surface 1112 to the perimeter of the bonding interface 1114. According to certain exemplary embodiments, the cutting surface 1112 is substantially planar; however, in other exemplary embodiments, the cutting surface 1112 is non-planar. Similarly, in certain exemplary embodiments, the bonding interface 1114 is substantially planar; however, in other exemplary embodiments, the bonding interface 1114 is non-planar. The surface of the bonding interface 1114 is substantially smooth; however, the surface is not smooth in other exemplary embodiments. Also, the bonding interface 1114 includes a compact central axis 1105 that extends centrally through the TSP compact 1110. Further, the bonding interface 1114 is formed having a bonding interface diameter 1115. In certain exemplary embodiments, the cutting surface 1112 is formed having a cutting surface diameter 1113 that is either equal to, greater than, or less than the bonding interface diameter 1115.

The substrate material 1150 is formed and fabricated similarly to the substrate material 300 (FIG. 3), except for its shape. The substrate material 1150 includes a bonding surface 1152, a mounting surface 1154, and a substrate sidewall 1156 extending from the perimeter of the bonding surface 1152 to the perimeter of the mounting surface 1154. The substrate material 1150 is formed having a substrate diameter 1151 substantially similar in size to the bonding interface diameter 1115. In certain exemplary embodiments, the mounting surface 1154 is substantially planar; however, in other exemplary embodiments, the mounting surface 1154 is non-planar. According to certain exemplary embodiments, the bonding surface 1152 is substantially non-planar. In certain exemplary embodiments, the bonding surface 1152 includes a recess 1158 formed therein, thereby also forming a protrusion area 1159 extending circumferentially around the recess 1158. The recess 1158 is circularly shaped and includes a recess diameter 1160 that is less than the bonding interface diameter 1115. Alternatively, the recess 1158 and the bonding interface 1114 are shaped differently in other exemplary embodiments. According to some exemplary embodiments, the recess 1158 is about 0.02 inches deep, but this recess 1158 is deeper or shallower in other exemplary embodiments. A portion of the bonding interface 1114 is positioned adjacently and coupled to the protrusion area 1159. Hence, the remaining portion of the bonding interface 1114 is disposed over the recess 1158. The substrate material 1150 includes a substrate central axis 1145 that extends centrally through the substrate material 1150. The surface of the bonding surface 1152 is substantially smooth; however, the surface is not smooth in other exemplary embodiments. Once the TSP compact 1110 is coupled, or bonded, to the substrate material 1150 pursuant to the description provided above, the compact central axis 1105 is aligned with the substrate central axis 1145 and the bonding interface 1114 is coupled adjacent to the bonding surface 1152. The bonding process is performed substantially similar to that previously described. During the bonding process, this recess 1158 overcomes the potential issue of a slow surface speed, or “cold spot”, forming in about the center of the cutter 1100, where the substrate material 1150 is positioned adjacent to the TSP compact 1110. This recess 1158 also allows for a better force distribution of the applied force and for melting of the cobalt or other attachment medium at a slower RPM. Also during the bonding surface, the cobalt can enter into this recess 1158 and solidify therein. In certain exemplary embodiments, the bonding interface 1114 also includes a recess (not shown) formed therein, similar to recess 1158 formed within the bonding surface 1152.

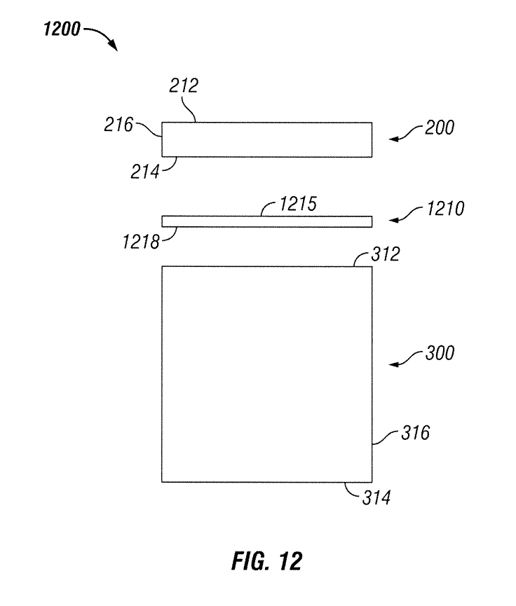

FIG. 12 shows an exploded cross-sectional view of a cutter 1200 in accordance with a sixth embodiment of the present invention. Referring to FIG. 12, cutter 1200 is similar to cutter 599 (FIG. 6), except that a foil 1210 is disposed between the TSP compact 200 and the substrate material 300. Thus, the cutter 1200 includes the TSP compact 200, the substrate material 300, and the foil 1210. For the sake of clarity, the presence of binder material within the substrate material 300, which is similar to the binder material 305 (FIG. 3), is not illustrated in FIG. 12.

The TSP compact 200 includes the cutting surface 212, the bonding interface 214, and the cutting table sidewall 216 extending from the perimeter of the cutting surface 212 to the perimeter of the bonding interface 214. The substrate material 300 includes the tungsten carbide powder 302 (FIG. 3) and also the binder material 305 (FIG. 3), such as cobalt. The substrate material 300 also includes the bonding surface 312, the mounting surface 314, and the substrate sidewall 316 extending from the perimeter of the bonding surface 312 to the perimeter of the mounting surface 314.

The foil 1210 includes a first surface 1215 and a second surface 1218 positioned opposite the first surface 1215. The foil 1210 is very thin and is fabricated from cobalt. In alternative exemplary embodiments, the foil 1210 is fabricated using other suitable materials, such as silver, copper, molybdenum, niobium, gold, platinum, palladium, ruthenium, rhodium, alloys thereof, or a refractory metal. In some exemplary embodiments, the foil 1210 is bonded to the substrate material 300 prior to being bonded to the TSP compact 200 using the TSP coupling device 500 (FIG. 5) described above. Thus, the second surface 1218 is coupled to the substrate material's bonding surface 312 using methods known to persons having ordinary skill in the art. Once the foil 1210 is bonded to the substrate material 300, the first surface 1215 of the foil 1210 is bonded to the TSP compact 200 via the TSP coupling device 500 (FIG. 5) and the process described above. The foil 1210 being disposed between the TSP compact 200 and the substrate 300 allows the bonding process to occur at a faster rate according to some exemplary embodiments. In yet other exemplary embodiments, the foil 1210 produces carbides during the bonding process which reduces, or better controls, the infiltration distance 610 (FIG. 6) of the binder 305 (FIG. 6) into the TSP compact 200. In some exemplary embodiments, such as in the use of a gold or gold alloy as the foil 1210, the foil 1210 melts prior to the cobalt 305 within the substrate 300 melting. The foil material 1210 infiltrates into the TSP compact 200 and coats the diamond crystals and diamond bonds. When the cobalt 305 infiltration follows, the cobalt 305 is isolated from the diamond crystals by the earlier wetting of the foil material 1210. In this manner the foil material 1210 acts as a retardant to graphitization of the diamond by the infiltrating cobalt 305.

Since the bonding method described above, which uses the TSP coupling device 500 (FIG. 5) or some other similar device type that generates frictional heat at the interface of the TSP compact and the substrate material, does not involve an additional HPHT press operation, nor an incremental leaching step, it is more economical. The apparatus and the bonding method described above achieve a superior bond in comparison to any known brazing method. Also, the apparatus and the bonding method described above can use the preferred bonding agent, cobalt, while controlling the flow of the cobalt into the TSP compact to avoid the deleterious effects cobalt can have on the working surface of the produced compact. Another advantage of the apparatus and method over the HPHT press process is that the process can be better monitored and controlled, such as allowing the control of torque, pressure, temperature and/or RPM to produce repeatable, predictable quality parts. Unlike an HPHT press process, the apparatus and the bonding method described above allow for direct visual observation of the process.

Another advantage of one or more exemplary embodiments of the present invention is that it allows the bonding of more exotic TSP materials than can be bonded by the traditional HPHT press process. For example, TSP compacts sintered with non- metallic catalysts, such as carbonates, or binderless sintered TSP compacts can be successfully joined to a substrate material using the process disclosed in one or more exemplary embodiments of the present invention.

Although each exemplary embodiment has been described in detail, it is to be construed that any features and modifications that are applicable to one embodiment are also applicable to the other embodiments. Furthermore, although the invention has been described with reference to specific embodiments, these descriptions are not meant to be construed in a limiting sense. Various modifications of the disclosed embodiments, as well as alternative embodiments of the invention will become apparent to persons of ordinary skill in the art upon reference to the description of the exemplary embodiments. It should be appreciated by those of ordinary skill in the art that the conception and the specific embodiments disclosed may be readily utilized as a basis for modifying or designing other structures or methods for carrying out the same purposes of the invention. It should also be realized by those of ordinary skill in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A method for fabricating a cutter, the method comprising:
obtaining a compact comprising a cutting surface, a bonding interface, and a cutting table sidewall extending from the perimeter of the cutting surface to the perimeter of the bonding interface;
obtaining a substrate material comprising a bonding surface, a mounting surface, and a substrate sidewall extending from the perimeter of the bonding surface to the perimeter of the mounting surface;
positioning at least a portion of the bonding interface adjacent at least a portion of the bonding surface;
rotating at least one of the substrate material and the compact producing a rotational differential between the substrate material and the compact;
increasing the temperature of at least the bonding surface to a first temperature; and
coupling the compact to the substrate material and forming the cutter.

2. The method of claim 1, wherein the compact is thermally stable prior to coupling the compact to the substrate.

3. The method of claim 1, wherein only the substrate material is rotated.

4. The method of claim 1, wherein only the compact is rotated.

5. The method of claim 1, wherein the substrate material is rotated in one direction and the compact is rotated in an opposite direction.

6. The method of claim 1, wherein the substrate material and the compact are rotated in the same direction, and wherein the substrate material is rotated at a different speed than the compact.

7. The method of claim 1, wherein the rotational differential ranges from between about 1,000 RPM to about 7,000 RPM.

8. The method of claim 1, wherein the substrate material further comprises a binder material at the bonding surface, and wherein the first temperature is equal to or greater than the melting temperature of the binder material.

9. The method of claim 8, wherein coupling the compact to the substrate material comprises:
melting the binder material within the substrate material;
infiltrating the binder material into the compact, the binder material proceeding an infiltrating distance into the compact from the bonding interface towards the cutting surface; and
ceasing rotation of the substrate material and the compact upon at least one of the substrate material and the compact experiencing a lateral displacement towards the other.

10. The method of claim 9, wherein the infiltrating distance ranges from about two percent to about eighty percent of the distance from the bonding interface to the cutting surface.

11. The method of claim 9, wherein the infiltrating distance ranges from about two percent to about sixty-seven percent of the distance from the bonding interface to the cutting surface.

12. The method of claim 9, wherein the infiltrating distance ranges from about two percent to about forty percent of the distance from the bonding interface to the cutting surface.

13. The method of claim 1, further comprising applying a first load on the compact in a direction towards the substrate material.

14. The method of claim 13, wherein the first load is applied on the compact after the rotation of the compact and the substrate material has ceased.

15. The method of claim 1, further comprising applying a second load on the substrate material in a direction towards the compact.

16. The method of claim 15, wherein the second load is applied on the substrate material after the rotation of the compact and the substrate material has ceased.

17. The method of claim 1, further comprising applying a first load on the compact in a direction towards the substrate material and applying a second load on the substrate material in a direction towards the compact.

18. The method of claim 1, wherein the shape of the bonding interface is complementary to the shape of the bonding surface.

19. The method of claim 1, wherein the bonding surface defines a recess formed therein and comprises a protrusion area formed around the perimeter of the bonding surface and surrounding the recess, the bonding surface comprising a first diameter and the recess comprising a second diameter, the second diameter being smaller than the first diameter.

20. The method of claim 19, wherein the bonding interface comprises a third diameter, the third diameter and the first diameter being about the same.

21. The method of claim 19, wherein the bonding interface comprises a third diameter, the third diameter being slightly smaller than the second diameter, wherein the bonding interface is insertable into the recess.

22. The method of claim 1, wherein the bonding interface comprises one or more protrusions extending outwardly away from the cutting surface, and wherein the bonding surface defines a groove formed therein, the groove being substantially circular, and wherein the protrusions are insertable into the groove.

23. The method of claim 1, wherein the average temperature of the compact is a second temperature and the average temperature of the substrate material is a third temperature when the temperature of at least the bonding surface is increased to the first temperature, the second temperature and the third temperature being different than the first temperature.

24. The method of claim 23, wherein the second temperature is lower than the third temperature, the second temperature and the third temperature being lower than the first temperature.

25. The method of claim 1, disposing a foil of material selected from a group consisting of cobalt, silver, copper, molybdenum, niobium, gold, platinum, palladium, ruthenium, rhodium, alloys thereof, and a refractory metal between the bonding interface and the bonding surface prior to rotating at least one of the substrate material and the compact.

26. An apparatus for fabricating a cutter, comprising
a first holder;
a compact comprising a cutting surface, a bonding interface, and a cutting table sidewall extending from the perimeter of the cutting surface to the perimeter of the bonding interface, the cutting surface being coupled to the first holder;
a second holder; and
a substrate material comprising a bonding surface, a mounting surface, and a substrate sidewall extending from the perimeter of the bonding surface to the perimeter of the mounting surface, the mounting surface being coupled to the second holder,
wherein at least a portion of the bonding interface is contacting at least a portion of the bonding surface, and
wherein at least one of the first holder and the second holder is rotatable.

27. The apparatus of claim 26, wherein the first holder comprises:
a first holding tool comprising a base and a sidewall extending outwardly from the perimeter of the base, the base and the sidewall defining a cavity therein;
a first drive base comprising a first end and a second end and inserted within the cavity, the first end coupled to the base, the first drive base and the sidewall forming a gap therebetween;
a first outer collet positioned within the gap and securing the positioning of the first drive base, the first outer collet comprising a first end extending further away from the base than the second end of the first drive base; and
a first inner collet positioned within the first outer collet and adjacent the second end of the first drive base, the first inner collet comprising an inner wall,
wherein the compact is coupled to the first inner collet, the inner wall surrounding at least a portion of the compact.

28. The apparatus of claim 27, wherein the second end of the first outer collet is tapered inwardly.

29. The apparatus of claim 26, wherein the second holder comprises:
a second holding tool comprising a base and a sidewall extending outwardly from the perimeter of the base, the base and the sidewall defining a cavity therein;
a second drive base comprising a first end and a second end and inserted within the cavity, the first end coupled to the base, the second drive base and the sidewall forming a gap therebetween;
a second outer collet positioned within the gap and securing the positioning of the second drive base, the second outer collet comprising a first end extending further away from the base than the second end of the second drive base; and
a second inner collet positioned within the second outer collet and adjacent the second end of the second drive base, the second inner collet comprising an inner wall,
wherein the substrate is coupled to the second inner collet, the inner wall surrounding at least a portion of the substrate.

30. The apparatus of claim 29, wherein the second end of the second outer collet is tapered inwardly.

31. The apparatus of claim 26, further comprising a control chamber, the control chamber comprising a first wall, a second wall, a door extending from the edge of the first wall to the edge of the second wall, and an enclosed area defined by at least the first wall, the second wall, and the door, wherein at least a portion of the first holder is coupled to the first wall, at least a portion second holder is coupled to the second wall, and at least a portion of the first holder and the second holder are housed within the enclosed area.

32. The apparatus of claim 31, wherein the environment of the enclosed area is controllable.

33. The apparatus of claim 32, wherein the environment comprises at least one of the temperature and the pressure.

34. A method for fabricating a cutter, the method comprising:
obtaining a compact comprising a cutting surface, a bonding interface, and a cutting table sidewall extending from the perimeter of the cutting surface to the perimeter of the bonding interface;
obtaining a substrate material comprising a bonding surface, a mounting surface, and a substrate sidewall extending from the perimeter of the bonding surface to the perimeter of the mounting surface;
bonding a foil to the bonding surface;
positioning at least a portion of the bonding interface adjacent at least a portion of foil bonded to the substrate;
rotating at least one of the foil bonded to the substrate material and the compact producing a rotational differential between the foil and the compact;
increasing the temperature of at least the bonding surface to a first temperature; and
coupling the compact to the substrate material and forming the cutter.

35. The method of claim 34, wherein the rotational differential ranges from between about 1,000 RPM to about 7,000 RPM.

36. The method of claim 34, wherein the substrate material further comprises a binder material, and wherein the first temperature is equal to or greater than the melting temperature of the binder material.

37. The method of claim 36, wherein coupling the compact to the substrate material comprises:
melting the binder material within the substrate material;
infiltrating the binder material into the compact, the binder material proceeding an infiltrating distance into the compact from the bonding interface towards the cutting surface; and
ceasing rotation of the substrate material and the compact upon at least one of the substrate material and the compact experiencing a lateral displacement towards the other.

38. The method of claim 37, wherein the infiltrating distance ranges from about two percent to about eighty percent of the distance from the bonding interface to the cutting surface.

39. The method of claim 37, wherein the foil melts and infiltrates into the compact prior to the binder material melting and infiltrating into the compact, the melted foil coating one or more crystals within the compact and being a retardant to graphitization of the crystals by the subsequent infiltrating binder material.

40. The method of claim 34, wherein the foil is formed using a material selected from a group consisting of cobalt, silver, copper, molybdenum, niobium, gold, platinum, palladium, ruthenium, rhodium, alloys thereof, and a refractory metal.
